(19) United States
(12) Patent Application Publication
(10) Pub. No.: US 2013/0015084 A1
(43) Pub. Date: Jan. 17, 2013

(54) DISPOSABLE PIZZA-BLOTTING COMPOSITE AND BOX ASSEMBLY

(71) Applicants: Bradley Hunter Farrell, Burbank, CA (US); Jennifer D. Stitz, North Hollywood, CA (US)

(72) Inventors: Bradley Hunter Farrell, Burbank, CA (US); Jennifer D. Stitz, North Hollywood, CA (US)

(21) Appl. No.: 13/626,811

(22) Filed: Sep. 25, 2012

Related U.S. Application Data
(63) Continuation-in-part of application No. 13/169,927, filed on Jun. 27, 2011.

(51) Int. Cl. F26B 3/00; B65D 77/00

(52) U.S. Cl. 206/216; 34/95; 34/355

(57) ABSTRACT

A food blotting composite includes an absorbent layer and a non-absorbent layer, the absorbent layer in one embodiment having an oleophilic surface and the non-absorbent layer having an oleophobic surface. The absorbent layer is physiologically safe for food contact applications, such as removing oil and grease from pizza and other cooked foods. A pizza box assembly and a blotting method also involve the pizza-blotting composite. In one embodiment the composite is positioned beneath the pizza with the absorbent layer facing upwardly to contact the underside of the pizza in use.

### CROSS-REFERENCE TO RELATED APPLICATION(S)

This application is a continuation-in-part of U.S. patent application Ser. No. 13/169,927, filed Jun. 27, 2011, and entitled DISPOSABLE PIZZA-BLOTTING COMPOSITE AND BOX ASSEMBLY INCLUDING SUCH COMPOSITE, the contents of which are expressly incorporated herein in their entirety.

### TECHNICAL FIELD

The present disclosure is directed to a disposable grease-absorbing device and method, and to a pizza box assembly including such a device.

### BACKGROUND

Many people enjoy “take-out” or delivered pizza as a convenient and economical meal, which has a wide array of options for satisfying individual tastes. Even the frozen pizza market has expanded in recent years, due to the introduction of gourmet toppings at a lower price point. Whether freshly made or frozen, one of the negative aspects of pizzas is their tendency to produce an oily or greasy surface when baked as the cheese and meat toppings release some of their oil content. As a result, eating a pizza is often a messy exercise.

In the past, some consumers have used napkins to blot excess oil and grease from a pizza's surface before eating to reduce their fat consumption. A problem with this approach is that the oil and grease tend to bleed through the napkin and transfer to the hands of the consumer, thus requiring the use of additional napkins.

Another proposal for blotting excess oil and grease from pizza is described in U.S. Pat. No. 6,578,285 to Turtzo. It involves a device having a support member with a handle and an absorbent pad for blotting the upper surface of a food item such as pizza. Absorbent structures for collecting grease in other contexts, particularly microwave ovens, are disclosed in U.S. Pat. Nos. 5,414,248 and 5,814,396.

A problem with conventional pizza delivery boxes is that oil and grease from pizza toppings (such as meat and cheese) tend to be absorbed by the box itself. Once oil has been absorbed into a box, the cardboard is no longer recyclable and must be incinerated or placed in a landfill.

What is needed in the industry is an economical pizza-blotting composite for effectively removing excess oil and grease from a pizza. Further, what is needed is a malleable composite that is easily folded after use to prevent oil from being transferred to the hands of the user. Finally, the industry would be well served by a pizza box assembly that includes such a pizza-blotting composite, such that the composite may be removed and discarded, enabling the box to be recycled.

### SUMMARY

An oil and grease-blotting composite according to the invention includes an absorbent layer and a non-absorbent layer, the absorbent layer having an oleophilic surface and the non-absorbent layer having an oleophobic or other suitable surface through which oil and grease cannot easily penetrate. The absorbent layer is low-linting and physiologically safe for food contact applications, such as removing oil and grease from pizza and other food items. The absorbent layer and the non-absorbent layer are joined to form a composite that may be dimensioned to cover all or a substantial portion of a pizza's surface. A pizza box assembly may also be provided with the oil and grease-blotting composite, in which the non-absorbent layer of the composite is secured to the interior top or bottom surface of the pizza box.

In one embodiment, the oil and grease-blotting composite is positioned against the bottom surface of a pizza box to absorb oil and grease from below, leaving the upper surface of the pizza undisturbed and appetizing. It has been found that positioning the composite below the pizza in this position, with the absorbent side up, is highly effective in extracting oil and grease from the pizza. Furthermore, the non-absorbent layer at the bottom of the composite substantially prevents oil and grease from reaching the cardboard of the box, preserving the ability of the box to be recycled after use. Alternatively, oil and grease blotting composite layers may be placed both above and below the pizza to extract oil and grease from both directions.

In a further embodiment, the non-absorbent layer may be a metallic foil or other metallic layer that reflects heat back toward the pizza or other food item, thereby minimizing the dissipation of heat through the box.

More specifically, in an embodiment, the invention comprises a disposable food-blotting composite having an absorbent layer comprising a physiologically safe cellulosic fibrous mat material with at least one oleophilic surface; and a flexible, non-absorbent layer underlying the absorbent layer, the non-absorbent layer including a malleable polymeric material having at least one oleophobic surface; wherein the absorbent layer and the non-absorbent layer are joined to one another to form a composite and wherein the composite is dimensioned to cover a substantial portion of a surface of an item of food with the absorbent layer configured to contact the item of food in use.

Alternatively, a pizza box assembly according to the invention may include a pizza box having a top and an inner receptacle covered by the top; a pizza-blotting composite including an absorbent layer comprising a physiologically safe material having at least one oleophilic surface; and a flexible, non-absorbent layer containing a malleable material having at least one oleophobic surface; wherein the absorbent layer and the non-absorbent layer are joined to one another to form a composite and wherein the composite is dimensioned to cover a substantial portion of a surface of a pizza with the absorbent layer facing the pizza in use, and wherein the non-absorbent layer is attached to the bottom interior surface of the pizza box.

A method of the invention for extracting oil and grease from a food item after cooking involves i) obtaining a composite sheet having an absorbent layer of a physiologically safe material having at least one oleophilic surface; and a flexible, non-absorbent layer underlying the absorbent layer, the non-absorbent layer including a malleable material having at least one oleophobic surface; wherein the absorbent layer and the non-absorbent layer are joined to one another to form a composite and wherein the composite is dimensioned to cover a substantial portion of a surface of an item of food with the absorbent layer facing the item of food; ii) placing the composite sheet above, below, or both above and below the item of food after it is cooked; and iii) discarding the composite sheet after oil and grease from the food item have been absorbed by the absorbent layer.

### BRIEF DESCRIPTION OF THE DRAWINGS

A full and complete description of the present storage system is provided herein with reference to the appended figures, in which:

FIG. 1 is a top plan view of a pizza-blotting composite, according to a first aspect herein;

FIG. 2 is a cross-sectional view of the pizza-blotting composite of FIG. 1, as taken along line II-II of FIG. 1;

FIG. 3 is a perspective view of a pizza box assembly containing the pizza-blotting composite of FIG. 1, according to another aspect provided herein;

FIG. 4 is a perspective view, partially broken away, of a pizza box assembly containing the pizza-blotting composite of FIG. 1, according to yet another aspect provided herein; and

FIG. 5 is a perspective view, partially broken away, of a pouch-like container for storing the composite and distributing it to consumers with the purchase of a food item, such as pizza.

### DETAILED DESCRIPTION

Reference is now made to the drawings for illustration of various embodiments of the present pizza-blotting composite and pizza box assembly containing such a pizza-blotting composite. While the discussions herein refer to a round composite, it should be understood that the composite may be made in any shape, as needs dictate, for example, to accommodate rectangular pizzas or to cover the top or bottom of a square or rectangular pizza box. Further, although the discussion herein focuses on absorbing oil from pizza surfaces, it should be understood that the composite described herein is equally well suited for absorbing oil and/or grease from other dishes, such as lasagna.

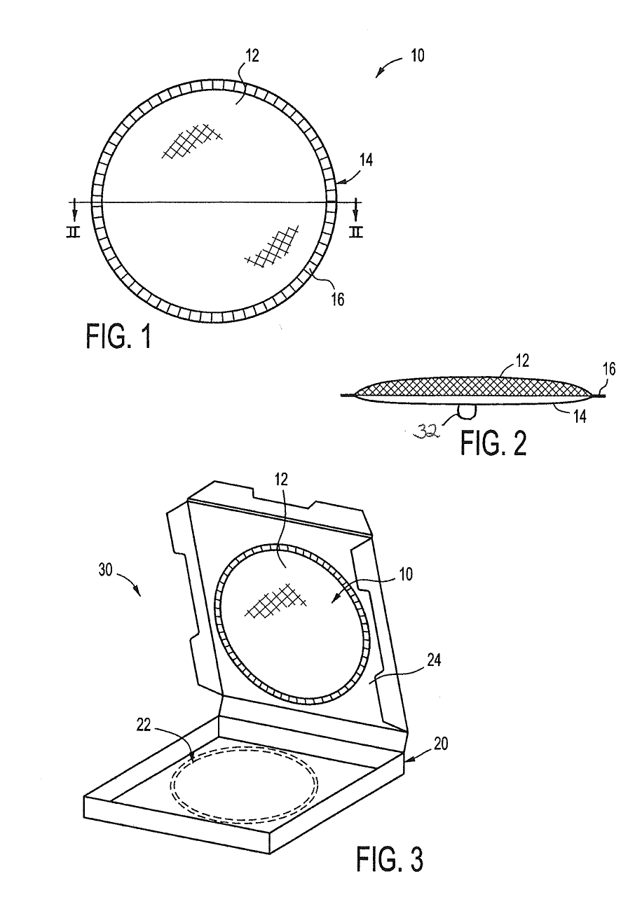

FIG. 1 is a pizza-blotting composite 10 having an absorbent layer 12 that is joined to a non-absorbent layer 14 (seen more clearly in FIG. 2). As illustrated, the composite 10 has a perimeter edge 16, which results from the joining of the absorbent layer 12 to the non-absorbent layer 14. The layers 12, 14 may be joined by any suitable means, including, but not limited to, and adhesive, film lamination, seaming, embossing, quilting, and surface bonding. The composite 10 is dimensioned to cover a substantial portion of a surface of a pizza and, accordingly, may be provided in a number of different sizes to accommodate pizzas of different diameters.

The absorbent layer 12 may be made of any suitable material that is capable of absorbing oil or grease in significant quantities. Such materials include, but are not limited to, bi-component micro-fibers, biodegradable fibers, and cellulosic fibers. Thus, the material of the absorbent layer 12 may include materials that are oleophilic, meaning that they have an affinity for oils and grease but not water. The absorbent layer 12 is physiologically safe for food contact applications and may be low-linting, such that the absorbent layer 12 does not leave lint on the food (e.g. pizza) after contact. By way of example only, the absorbent layer 12 may be a nonwoven web or mat of fibrous material.

The non-absorbent layer 14 (seen in FIG. 2) may be made of any suitable non-absorbent material that is not permeable by oils or grease. Such materials include oleophobic fiber webs, polymeric films and metallic coatings and foils (such as aluminum foil). Advantageously, when the non-absorbent layer 14 is made of foil, the composite 10 may have a desirable degree of malleability, such that the composite may be crumpled after use for convenient disposal without the user having to contact the oil-soaked absorbent layer 12.

In an exemplary embodiment, the absorbent layer 12 may be made of cellulosic fibers and the non-absorbent layer 14 may be made of a plastic (polymeric) film or metallic foil. More specifically, in one embodiment the absorbent layer 12 may be made of four to six layers of cellulose wadding having a basis weight of 12 to 18 pounds. The material may be virgin material that is biodegradable and recyclable. The sheets of wadding may be “pinned” together initially in an embossing type process to form a friction connection that creates a self-supporting sheet of absorbent material. An example of such absorbent material is the cellulose sheeting sold by Pregis Corporation under the trademark “Cushion Pack”.

As described, the absorbent layer 12 is backed by the non-absorbent layer 14, which may be a polymeric film, such as polyethylene, that is glued or otherwise affixed to the absorbent layer to form the composite 10. In one embodiment, the composite 10 may be biodegradable.

In use, the composite 10 is placed against a pizza or other food item from which oil or grease is to be blotted with the absorbent layer 12 in contact with the food item. The composite 10 may contact either an upper or lower surface of the food, as desired, to extract oil or grease without adversely affecting the food. In the case of pizza, which is commonly placed in a box for transportation, this leads to at least the following two potential positions of the composite 10 relative to the box.

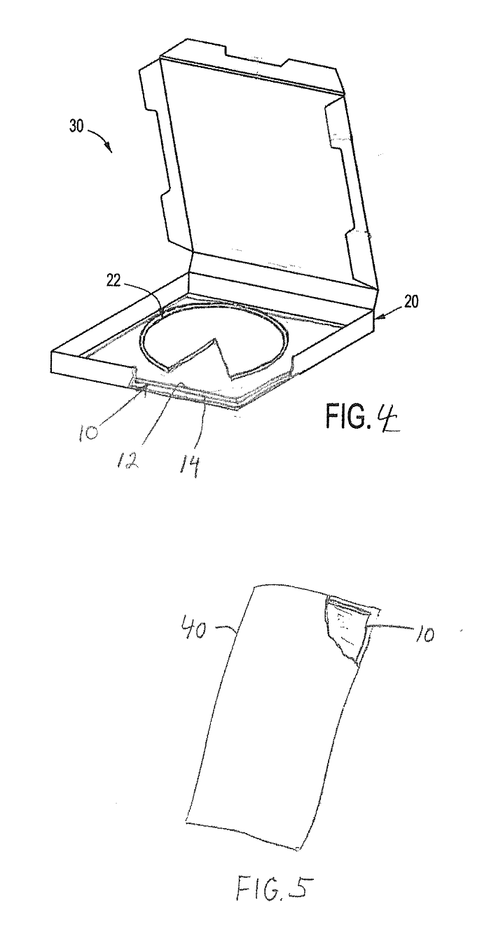

FIG. 3 illustrates a pizza box assembly 30 that includes a pizza box 20 and the pizza-blotting composite 10 shown in FIGS. 1 and 2. The pizza box 20 is a standard collapsible box used commonly in the industry, having an inner cavity or receptacle 22 for holding the pizza and a top 24 of the box 20, such that the absorbent layer 12 faces the inner receptacle 22. The composite 10 may be attached to the interior top 24 of the box 20 by any suitable means, including adhesives. In one aspect, the composite 10 may be removed after use and the pizza box 20 may be recycled.

FIG. 4 illustrates an alternative arrangement of the composite 10 relative to the pizza box, wherein the composite is located within the inner receptacle 22 of the pizza box at a location beneath the pizza. When the pizza in the box is cut or “scored” oil and grease from the pizza is efficiently wicked to the underside by the absorbent layer 12 without disturbing the upper surface of the pizza as can occur when its upper surface is blotted. Therefore, the arrangement of FIG. 4 operates advantageously in a surprisingly efficient manner to extract undesired oil and grease.

When the composite 10 is used beneath the pizza in the configuration of FIG. 4, the pizza may be cut prior to or after being placed on the composite. Due to the durable nature of the composite, it is not normally severed when a rolling cutter is used on the pizza.

Placement of the composite beneath the pizza enables excess oil and grease to pass downwardly to the composite for efficient absorption by the absorbent layer 12. The oil and grease cannot pass beneath the composite 10, however, because the non-absorbent layer 14 acts as a barrier. The bottom of the pizza box 20 therefore remains oil and grease-free, enabling it to be recycled.

As illustrated in FIG. 4, the composite 10 may be square or any other suitable shape to cover the bottom of the pizza box. Particularly when the composite is placed beneath a pizza or other food item, it may be desirable to cover the entire bottom of the container in which the food item is placed. Alternatively, the composite 10 placed beneath a pizza may be circular and dimensioned to match the outline of the pizza.

In other instances, such as when pizza or other food items are consumed on the premises of a restaurant, the composite can still be used under the food to absorb the oil and grease. In any case, once the pizza is finished, the composite may be folded inwardly onto itself without touching the grease-saturated absorbent layer 12 by grasping the non-absorbent layer 14.

When the composite 10 is used to blot a pizza or other food item from above, the non-absorbent layer 14 may have a flexible tab, string, or other physical feature 32 enabling the user to lift the composite away from the food without touching the saturated absorbent layer 12. The weight of the absorbed oil and grease then causes the composite 10 to hang downwardly with the grease-impermeable non-absorbent layer 14 on the outside, facilitating disposal of the composite without getting oil or grease on the user's hands.

When the non-absorbent layer 14 is metallic, the composite 10 also serves an additional purpose of retaining heat within the pizza by reflection in either an up or down direction, depending on the position of the composite.

In another form, separate pieces of the composite 10 may be provided above and below a pizza with the absorbent layer 12 facing and in contact with the surfaces of the pizza to absorb oil and grease from both the top and the bottom of the pizza. Alternatively, the top and bottom layers of the composite 10 may comprise a single sheet of the composite that extends underneath the pizza and is folded over to also engage the top of the pizza to absorb oil and grease from the top and bottom of the pizza simultaneously.

The foldable nature of the composite 10 enables it to be packaged in a compact and inexpensive package 40 which may be in the form of a sealed plastic, paper or foil-backed pouch, as illustrated in FIG. 5. In this form, the composite is suitable for distribution with a take-out pizza or other food item for convenient use by the consumer in extracting oil and grease from the food item. In situations where a composite 10 is provided above or below a pizza in the box of FIG. 3 or FIG. 4, another composite 10 might also be provided for manual use by the consumer to further reduce the quantity of oil and/or grease consumed.

The preceding discussion merely illustrates the principles of the present pizza-blotting composites and pizza box assemblies containing such pizza-blotting composites. It will thus be appreciated that those skilled in the art may be able to devise various arrangements, which, although not explicitly described or shown herein, embody the principles of the inventions and are included within their spirit and scope. Furthermore, all examples and conditional language recited herein are principally and expressly intended to be for educational purposes and to aid the reader in understanding the principles of the invention and the concepts contributed by the inventor to furthering the art and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. Terms such as “upper”, “top”, and “lower” are intended only to aid in the reader's understanding of the drawings and are not to be construed as limiting the invention being described to any particular orientation or configuration.

This description of the exemplary embodiments is intended to be read in connection with the figures of the accompanying drawings, which are to be considered part of the entire description of the invention. The foregoing description provides a teaching of the subject matter of the appended claims, including the best mode known at the time of filing, but is in no way intended to preclude foreseeable variations contemplated by those of skill in the art.

What is claimed is:

1. A disposable food-blotting composite comprising:
an absorbent layer comprising a physiologically safe cellulosic fibrous mat material having at least one oleophilic surface; and
a flexible non-absorbent layer underlying the absorbent layer, the non-absorbent layer comprising a malleable polymeric material having at least one oleophobic surface,
wherein the absorbent layer and the non-absorbent layer are joined to one another to form a composite and wherein the composite is dimensioned to engage a substantial portion of a surface of an item of food with the absorbent layer configured to contact the item of food in use.

2. The food-blotting composite of claim 1, wherein the absorbent layer is joined to the non-absorbent layer by one of an adhesive, film lamination, seaming, embossing, quilting, and surface bonding.

3. The food-blotting composite of claim 1, further comprising a pizza box having a top and an inner receptacle covered by the top, the non-absorbent layer being attached to an interior surface of the pizza box and configured to place the absorbent layer in contact with a pizza in use.

4. The food-blotting composite of claim 3 wherein the non-absorbent layer is attached to the bottom interior surface of the pizza box with the absorbent layer facing upwardly to contact a pizza in use.

5. A pizza box assembly comprising:
a pizza box comprising a top and an inner receptacle covered by the top;
a pizza-blotting composite comprising an absorbent layer comprising a physiologically safe material having at least one oleophilic surface; and
a non-absorbent layer comprising a malleable material having at least one oleophobic surface,
wherein the absorbent layer and the non-absorbent layer are joined to one another to form a composite and wherein the composite is dimensioned to engage a substantial portion of a surface of a pizza with the absorbent layer facing the pizza in use, and wherein the non-absorbent layer is attached to the bottom interior surface of the pizza box.

6. The pizza box assembly of claim 5, wherein the pizza-blotting composite is secured to the bottom interior surface of the pizza box by an adhesive.

7. The pizza box assembly of claim 5, wherein the pizza-blotting composite is removable from the pizza box prior to recycling.

8. The pizza-blotting composite of claim 5, wherein the absorbent layer is comprised of bi-component micro fibers.

9. The pizza-blotting composite of claim 5, wherein the absorbent layer is comprised of biodegradable fibers.

10. The pizza-blotting composite of claim 5, wherein the absorbent layer is comprised of cellulosic fibers, and wherein the non-absorbent layer comprises a polymeric film.

11. The pizza-blotting composite of claim 5, wherein the absorbent layer is comprised of cellulosic fibers, and wherein the non-absorbent layer comprises a metallic foil.

12. The pizza-blotting composite of claim 5, wherein the absorbent layer is joined to the non-absorbent layer by one of an adhesive, film lamination, seaming, embossing, quilting, and surface bonding.

13. A method of extracting oil and grease from a food item after cooking, the method comprising:
i) obtaining a composite sheet comprising:
an absorbent layer comprising a physiologically safe material having at least one oleophilic surface; and
a flexible, non-absorbent layer underlying the absorbent layer, the non-absorbent layer comprising a malleable material having at least one oleophobic surface,
wherein the absorbent layer and the non-absorbent layer are joined to one another to form a composite and wherein the composite is dimensioned to engage a substantial portion of a surface of an item of food with the absorbent layer facing the item of food;
ii) placing the composite sheet beneath the item of food after it is cooked; and
iii) discarding the composite sheet after oil and grease from the food item have been absorbed by the absorbent layer.

14. The method of claim 13 wherein the food item is pizza and the composite sheet is placed underneath the pizza after the pizza is cooked and before it is cut into pieces for eating.

15. The method of claim 13 wherein:
the absorbent layer comprises cellulosic fibers; and
the non-absorbent layer comprises polyethylene.

16. The method of claim 13 wherein:
the non-absorbent layer comprises a metallic foil.

17. The method of claim 13 wherein:
the composite sheet is disposed in the bottom of a pizza box with the absorbent layer facing upwardly to contact the pizza.
